(19) United States
(12) Patent Application Publication
(10) Pub. No.: US 2005/0078958 A1
(43) Pub. Date: Apr. 14, 2005

(54) Optical csma/cd technique

(76) Inventors: Chang-Joon Chae, Donoaster Victoria (AU); Rodney Tucker, Hawthorn Victoria (AU); Elaine Wong, Carlton Victoria (AU)

Correspondence Address: Stephen M De Klerk;Blakely Sokoloff Taylor & Zafman, 12400 Wilshire Boulevard, Seventh Floor, Los Angeles, CA, 90025, US

(21) Appl. No.: 10/486,527

(22) PCT Filed: Jul. 30, 2002
(86) PCT No.: PCT/AU02/01011

(30) Foreign Application Priority Data
Aug. 10, 2001 (AU) PR 6932
Apr. 12, 2002 (AU) PS 1729

(51) Int. Cl. H04B 10/24

(52) U.S. Cl. 398/41

(57) ABSTRACT

An optical network (10) comprising a plurality of optical network units (12), an optical line terminal unit, and a first optical combiner unit (20), wherein the optical network units (12) are optically connected to the first optical combiner unit (20) via respective optical connections in a manner such that optical transmissions from the optical network units (12) are combined onto one optical line connection to the optical line terminal unit, a redirection unit (24) for redirecting a portion of a transmission signal on the optical line connection towards the first combiner unit (20) each optical network unit (12) comprising an optical transmitter unit (14) for transmitting an optical signal to the optical line terminal unit, and a CSMA/CD unit (16) arranged, in use, to tap off at least a portion of the redirected portion of the transmission signal from the optical connection between the optical network unit (12) and the first combiner unit (20), wherein the CSMA/CD unit (16) is further arranged to control the transmitter unit (14) based on the tapped off portion of the redirected portion of the transmission signal.

### FIELD OF THE INVENTION

The present invention relates broadly to an optical network, to an optical network unit for use in an optical network, and to an optical combiner unit for use in an optical network. The invention further relates to a method of conducting upstream transmission in an optical network.

### BACKGROUND OF THE INVENTION

It has been proposed to transport Ethernet frames over a passive optical network between a central office/server and individual subscribers. This proposal is particularly relevant to Access networks, i.e. the “last mile” in distributing data to individual subscribers. In the Access environment, an emphasis must be placed on providing inexpensive solutions, which is why other proposals such as implementing wavelength division multiplexed (WDM) based optical access networks may not be preferred.

In the electrical domain such as in the majority of current internet traffic at the Access level, a “carrier sense multiple access with collision detection” (CSMA/CD) protocol is often used. In the electrical domain, the CSMA/CD technique involves both the electrical line terminal (i.e. at the central office/server) and the electrical network units, i.e. subscribers, to determine whether a collision has occurred between upstream transmissions from individual electrical network units to the electrical line terminal. In the event of a collision having occurred, the transmission of individual electrical network units is stopped and a retry transmission is conducted after predetermined delay periods. In other words, the CSMA/CD technique is substantially a cruel protocol based on retries until a successful transmission, i.e. without collision occurs, rather than relying on a complex synchronisation protocol.

However, when applying the CSMA/CD technique to passive optical networks, it is very inefficient to involve both an optical line terminal and the optical network units in the CSMA/CD process analogous to its use in the electrical domain. The inefficiencies are caused by the long distance between the optical line terminal and optical coupler elements used for the last mile distribution to the individual optical network units on the one hand, and the short distance between the optical network units and the optical coupler element on the other. The inefficiency is related to the relatively short packet transmission time in the optical domain. The limiting factor in the application of the CSMA/CD protocol in high-speed passive optical networks is thus the low packet transmission time/propagation delay ratio.

At least preferred embodiments of the present invention therefore seek to provide an application of the CSMA/CD technique to passive optical networks which can address the above mentioned inefficiency.

### SUMMARY OF THE INVENTION

In accordance with a first aspect of the present invention there is provided an optical network comprising a plurality of optical network units, an optical line terminal unit, and a first optical combiner unit, wherein the optical network units are optically connected to the first optical combiner unit via respective optical connections in a manner such that optical transmissions from the optical network units are combined onto one optical line connection to the optical line terminal unit, a redirection unit for redirecting a portion of a transmission signal on the optical line connection towards the first combiner unit, each optical network unit comprising an optical transmitter unit for transmitting an optical signal to the optical line terminal unit, and a dedicated CSMA/CD unit associated with the optical transmitter unit and arranged, in use, to tap off at least a portion of the redirected portion of the transmission signal from the optical connection between the optical network unit and the first combiner unit, wherein the CSMA/CD unit is further arranged to control the transmitter unit based on the tapped off portion of the redirected portion of the transmission signal.

Preferably, the first optical combiner unit comprises an optical star coupler.

In one embodiment, the redirection unit comprises a reflection grating for reflecting the portion of the transmission signal. The reflection grating advantageously comprises a Bragg reflection grating.

In another embodiment, the redirection unit comprises a tap unit for tapping off the portion of the transmission signal, a second optical combine unit, and an optical redirecting connection disposed between the tap unit and the second optical combiner unit for redirecting the tapped off portion of the transmission signal towards the first optical combiner unit. The first and second combiner units may be implemented as one combiner unit.

In another embodiment, the redirection unit and the first optical combiner unit are implemented as a 3×N optical combiner, wherein two of the, in use, upstream ports are interconnected for, in use, effecting the redirecting. The two upstream ports may be interconnected through an optical isolator, depending on the type of transmitter used.

The optical transmitter unit may comprise a light emitting diode or a laser source or any other suitable light source.

The optical network may comprise an optical access network.

In one embodiment, the CSMA/CD unit is arranged to control the transmitter unit based on the intensity of the tapped off portion of the redirected portion of the transmission signal. Advantageously, the CSMA/CD is arranged to effect stopping transmission from the transmitter unit when the intensity of the tapped off portion is equal to or exceeds a predetermined threshold value.

The CSMA/CD unit may be arranged to effect restarting of the transmission from the transmitter unit after a predetermined delay period. In such an embodiment, the CSMA/CD units of the respective optical network units may be arranged to restart the transmission from the respective transmitter units after different delay periods. Accordingly, a hierarchy or preference scheme may be implemented.

The CSMA/CD unit may comprise an optical tap unit for tapping off the portion of the redirected transmission signal. The CSMA/CD unit may comprise an optical circulator for tapping off the redirected transmission signal.

In a preferred embodiment, the redirected portion of the transmission signal is a dedicated portion for the redirecting process as opposed to other portions carrying data intended for transmission to the optical line terminal unit.

The redirection unit may further comprise means for jamming of the redirected portion of the transmission signal. The means for jamming the redirected signal may comprise means for combining copies of the redirected portion of the transmission signal, wherein, in use, an optical delay is imposed on one of the copies prior to the combining. Alternatively or additionally, the means for effecting the jamming of the redirected portion of the transmission signal may comprise an electronic circuit for manipulating the redirected signal.

In accordance with a second aspect of the present invention there is provided an optical network unit for use in an optical network comprising a plurality of optical network units, an optical line terminal unit, and a first optical combiner unit, the optical network units being optically connected to the first optical combiner unit via respective optical connections in a manner such that optical transmissions from the optical network units are combined onto one optical line connection to the optical line terminal unit, and a redirection unit for redirecting a portion of a transmission signal on the optical line connection towards the first combiner unit, the optical network unit comprising an optical transmitter unit for, in use, transmitting an optical signal towards the optical line terminal unit, and a dedicated CSMA/CD unit associated with the optical transmitter unit and arranged, in use, to tap off at least a portion of the redirected portion of the transmission signal from the optical connection between the optical network unit and the first combiner unit, wherein the CSMA/CD unit is further arranged to control the transmitter unit based on the tapped off portion of the redirected portion of the transmission signal.

The optical transmitter unit may comprise a light emitting diode or a laser source or any other suitable light source.

In one embodiment, the CSMA/CD unit is arranged to control the transmitter unit based on the intensity of the tapped off portion of the redirected portion of the transmission signal. Advantageously, the CSMA/CD is arranged to effect stopping transmission from the transmitter unit when the intensity of the tapped off portion is equal to or exceeds a predetermined threshold value. The CSMA/CD unit may be arranged to effect restarting of the transmission from the transmitter unit after a predetermined delay period.

The optical network may comprise an optical access network.

In accordance with a third aspect of the present invention there is provided an optical combiner unit for use in an optical network comprising a plurality of optical network units, an optical line terminal unit, the optical network units being optically connected to the optical combiner unit via respective optical connections in a manner such that optical transmissions from the optical network units are combined onto one optical line connection to the optical line terminal unit, the optical combiner unit comprising a redirection unit for, in use, redirecting a portion of a transmission signal on the optical line connection to each optical network unit, wherein the redirected portion is chosen in a manner which provides, in use, that the redirected portion of the transmission signal functions as a reference signal in a CSMA/CD technique conducted at the optical network units, and means for jamming of the redirected portion of the transmission signal.

The means for jamming the redirected portion of the transmission signal may comprise means for combining copies of the redirected portion of the transmission signal, wherein, in use, an optical delay is imposed on one copy prior to the combining. Alternatively or additionally, the means for effecting the jamming of the redirected portion of the transmission signal may comprise an electronic circuit for manipulating the redirected signal. The optical network may comprise an optical access network.

In accordance with a fourth aspect of the present invention there is provided a method of conducting upstream transmissions from optical network units in an optical network the method comprising the steps of combining optical transmissions from the optical network units onto one optical line connection, redirecting a portion of a transmission signal on the optical line connection back towards to the network units, tapping off at least a portion of the redirected portion of the transmission signal at each optical network unit utilising a dedicated CSMA/CD unit, and controlling transmissions from the optical network units based on the tapped off portion of the redirected portion of the transmission signal.

In one embodiment, the step of controlling the transmissions from the optical network units comprises determining the intensities of the tapped off portions of the redirected portion of the transmission signal. Advantageously, the step of controlling comprises effecting stopping transmissions from individual optical network units when the respective intensity of the tapped off portion is equal to or exceeds predetermined threshold values. The step of controlling may further comprise restarting of the transmission from the individual optical network units after predetermined delay periods. In such an embodiment, the step of controlling the respective optical network units may comprise restarting the transmissions from the respective optical network units after different delay periods.

The method may further comprise the step of jamming the redirected portion of the transmission signal. The jamming of the redirected portion of the transmission signal may comprise combining copies of the redirected portion of the transmission signal, wherein an optical delay is imposed on one of the copies prior to the combining. Alternatively or additionally, the jamming of the redirected portion of the transmission signal may comprise utilising an electronic circuit.

The optical network may comprise an optical access network.

### BRIEF DESCRIPTION OF THE DRAWINGS

Preferred embodiments of the present invention will now be described, by way of example only, with reference to the accompanying drawings.

FIG. 1 is a schematic drawing illustrating an optical network embodying the present invention.

FIG. 2 is a schematic drawing illustrating another optical network embodying the present invention.

FIG. 3 is a schematic drawing illustrating an Access optical network embodying the present invention.

FIG. 4 is a schematic drawing illustrating an optical combiner/distribution unit embodying the present invention.

FIG. 5 is a schematic drawing illustrating an optical network unit embodying the present invention.

FIG. 6 is a schematic drawing illustrating another optical network embodying the present invention.

FIG. 7 is a schematic drawing illustrating an optical combiner/distribution unit embodying the present invention.

FIG. 8 is a schematic drawing illustrating another optical combiner/distribution unit embodying the present invention.

### DETAILED DESCRIPTION OF THE EMBODIMENTS

The preferred embodiments described provide an optical network suitable for implementation of a CSMA/CD protocol in a passive optical network environment.

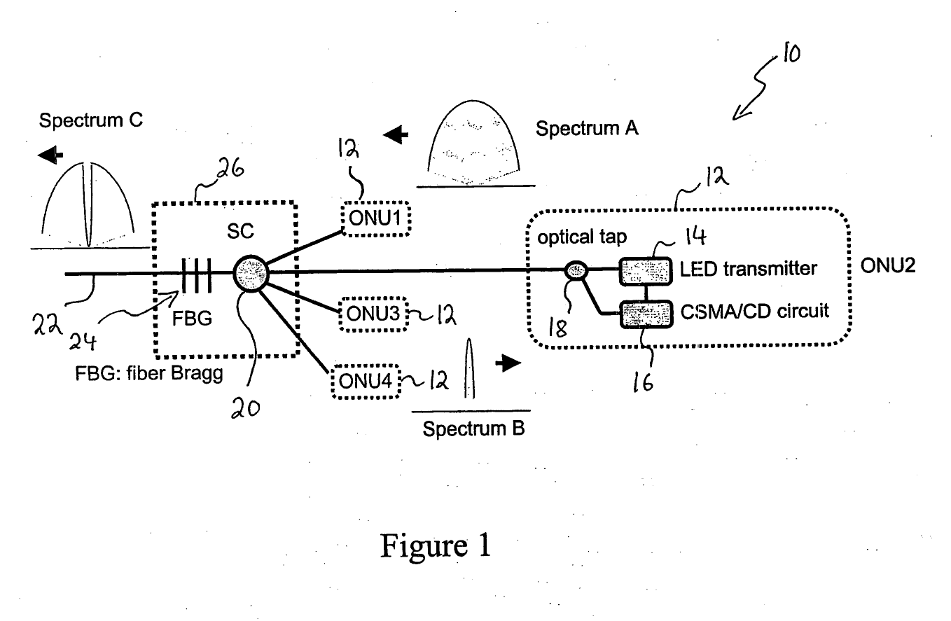

In FIG. 1, the optical network 10 comprises a plurality of optical network units 12, one of which is shown in more detail in FIG. 1. Each optical network unit 12 comprises an optical transmitter in the form of a light emitting diode (LED) 14. Each optical network unit 12 further comprises a CSMA/CD circuit 16 which is adapted to control the LED transmitter 14. Furthermore, the CSMA/CD circuit 16 is adapted to receive a tapped off optical signal propagating towards the optical network unit 12, which is tapped off by optical tap 18 of the optical network unit 12.

The optical network 10 further comprises an optical star coupler 20 by way of which downstream transmissions on an optical network connection 22 are distributed to the individual optical network units 12 and by way of which upstream transmissions from the individual optical network units 12 are combined onto the optical network connection 22 for transmission to an optical line terminal (not shown). A redirection unit in the form of a fibre Bragg grating 24 is located just after the star coupler 20, in the preferred embodiment within a combiner/distribution unit 26 located e.g. in a kerb side location. In the following, the operation of the optical network 10 to implement an efficient optical CSMA/CD technique for e.g. Ethernet over passive optical network will be described.

The LED transmitter 14 of an individual optical network unit 12 emits light having an optical spectrum A depicted in FIG. 1 toward the star coupler 20. The fibre Bragg grating 24 reflects only a part of spectrum A, and thereby all the optical networks units 12 receive a reflected spectrum B depicted in FIG. 1.

At each optical network unit 12, the optical tab 18 is used to tap off a small portion of power received in a direction towards the optical network units 12 to feed the CSMA/CD circuit 16.

The CSMA/CD circuit 16 can thus effectively sense the presence of an optical signal just after the star coupler 20. If any of the other optical network units 12 transmits at the same time, the optical power to the CSMA/CD circuit 16 will increase due to the overlap of the two packets (frames), i.e. two spectra of the type of spectrum B depicted in FIG. 1. The CSMA/CD circuit 16 detects the change in the received power and based on that change decides whether a collision has occurred. The CSMA/CD circuit 16 will then notify the LED transmitter 14 to either continue or stop transmission for a later retry.

Importantly, it is noted that the optical line terminal (not shown) of the optical network 10 remains passive during this entire process and just receives the spectrum C depicted in FIG. 1 to recover the signal transmitted by a particular optical network unit 12. Accordingly, due to the not-involvement of the optical line terminal, the optical network 10 embodying the present invention can provide the implementation of an efficient optical CSMA/CD technique for Ethernet over passive optical network.

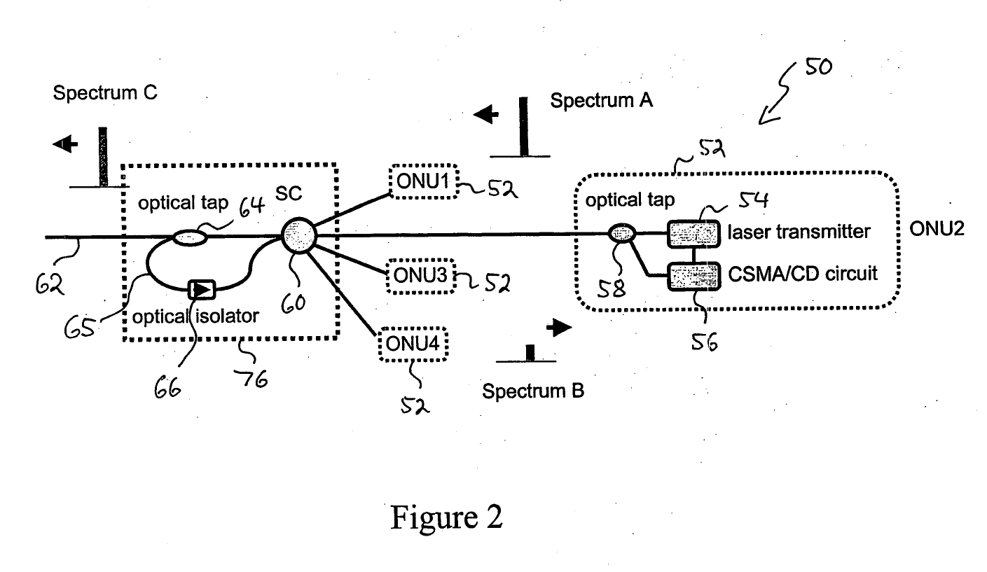

In an alternative embodiment shown in FIG. 2, an optical network 50 comprises a plurality of optical network units 52, one of which is shown in more detail in FIG. 2. Each optical network unit 52 comprises an optical transmitter in the form of a laser transmitter 54. Each optical network unit 52 further comprises a CSMA/CD circuit 56 which is adapted to control the laser transmitter 54. Furthermore, the CSMA/CD circuit 56 is adapted to receive a tapped off optical signal propagating towards the optical network unit 52, which is tapped off by optical tap 58 of the optical network unit 52.

The optical network 50 further comprises an optical star coupler 60 by way of which downstream transmissions on an optical network connection 62 are distributed to the individual optical network units 52 and by way of which upstream transmissions from the individual optical network units 52 are combined onto the optical network connection 62 for transmission to an optical line terminal (not shown). A redirection unit in the form of an optical tap 64, an optical redirecting connection 65, including an optical isolator 66, back to the star coupler 60 is located just after the star coupler 60, in the preferred embodiment within a combiner/distribution unit 76 located e.g. in a kerb side location. In the following, the operation of the optical network 50 to implement an efficient optical CSMA/CD technique for e.g. Ethernet over passive optical network will be described.

The laser transmitter 54 of an individual optical network unit 52 emits light having an optical spectrum A depicted in FIG. 2 toward the star coupler 60. The tap 64 taps off a portion of spectrum A, and all the optical networks units 52 receive a reflected spectrum B depicted in FIG. 2 due to the redirecting via connection 65 and the star coupler 60.

At each optical network unit 52, the optical tab 58 is used to tap off a small portion of power received in a direction towards the optical network units 52 to feed the CSMA/CD circuit 56.

The CSMA/CD circuit 56 can thus effectively sense the presence of an optical signal just after the star coupler 60. If any of the other optical network units 52 transmits at the same time, the optical power to the CSMA/CD circuit 56 will increase due to the overlap of the two packets (frames), i.e. two spectra of the type of spectrum B depicted in FIG. 1. The CSMA/CD circuit 56 detects the change in the received power and based on that change decides whether a collision has occurred. The CSMA/CD circuit 56 will then notify the laser transmitter 54 to either continue or stop transmission for a later retry.

Again, it is noted that the optical line terminal (not shown) of the optical network 50 remains passive during this entire process and just receives the spectrum C depicted in FIG. 2 to recover the signal transmitted by a particular optical network unit 52. Accordingly, due to the not-involvement of the optical line terminal, the optical network 50 embodying the present invention can be used to implement an efficient optical CSMA/CD technique for Ethernet over passive optical network.

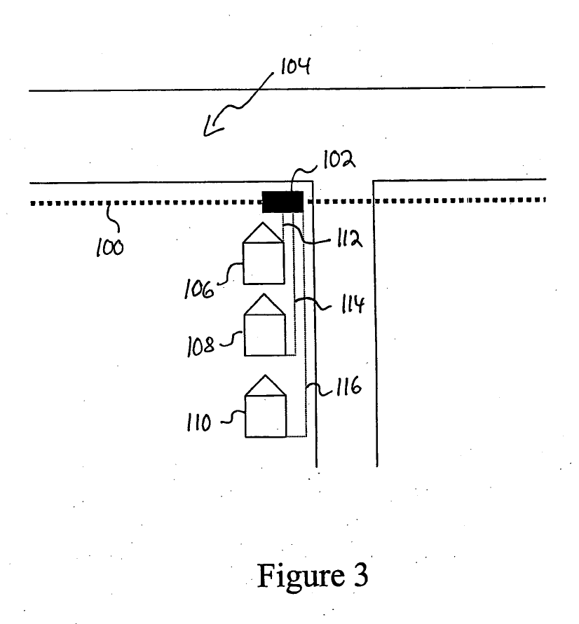

In FIG. 3, one application of the present invention in a schematic actual environment is shown. A main passive optical network connection 100 is present in-ground with an optical network distribution box 102 located kerb side of a main street 104. Within the distribution box 102, a combiner/distribution unit of the type of the combiner/distribution units 26, 76 described above with reference to FIGS. 1 and 2 respectively, is located to distribute data to individual households 106, 108 and 110 via individual in-ground optical connections 112, 114, and 116.

Within each of the households 106, 108, 110, an optical network unit of the type of optical network units 12 and 52 described above with reference to FIGS. 1 and 2 respectively is located.

In the scenario illustrated in FIG. 3, upstream transmissions from the individual households 106, 108, 110 will be conducted based on a CSMA/CD protocol, again as described above with reference to FIGS. 1 and 2.

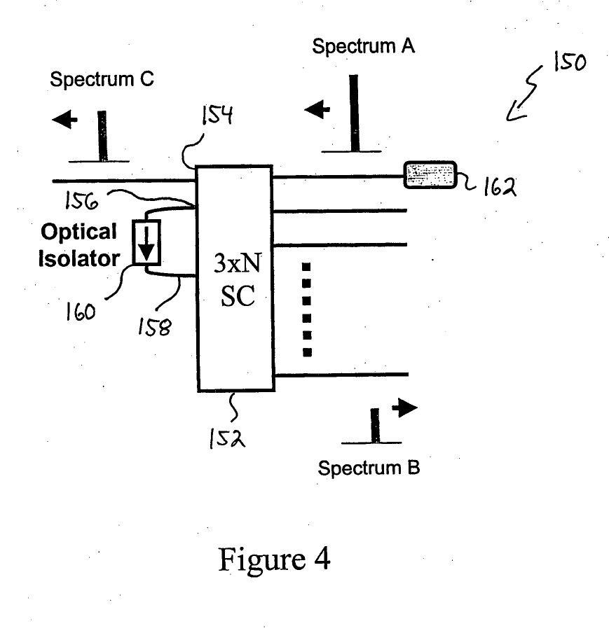

In FIG. 4, in another embodiment of the present invention, a combiner/distribution unit 150 comprises an optical coupler in the form of a 3×N coupler 152. A first upstream port 154 is used for transmission (spectrum C) to an optical terminal unit (not shown), while the other two upstream ports 156, 158 are interconnected though an optical isolator 160. Thus, a portion (spectrum B) of the original transmission signal (spectrum A) is redirected towards the various optical network units 162 through the N downstream ports of the 3×N coupler 152, for implementing a CSMA/CD technique embodying the present invention.

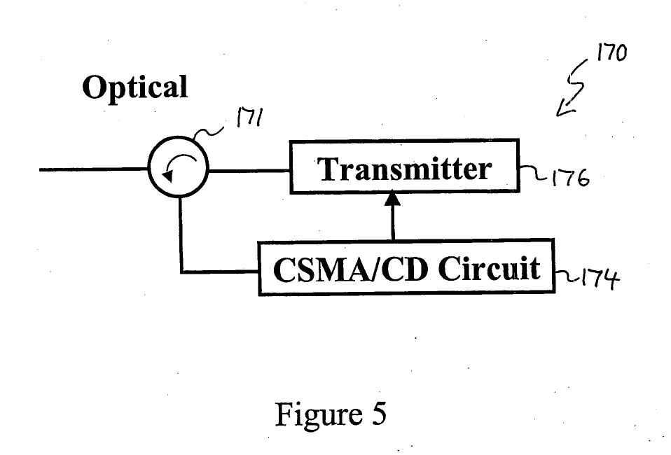

In FIG. 5, in another optical network unit 170 embodying the present invention, portions of transmission signals redirected towards the optical network unit 170 are tapped off utilising an optical circulator 171 for processing by a CSMA/CD circuit 174 controlling a transmitter 176 of the optical network unit 170, for implementing a CSMA/CD technique embodying the present invention.

The above described embodiments provide redirection of optical signals just after a remote coupler, e.g. a remote star coupler (compare FIG. 4) through an optical loop-back to e.g. implement optical CSMA/CD protocol for upstream access in Ethernet over passive optical network. The redirected portion of the transmission signal can be a dedicated portion for the redirecting process as opposed to other portions carrying data intended for transmission to the optical line terminal unit, which improves security in avoiding redirecting of someone's data to various network units. A further improvement will now be described, which also relates to the possibility of eavesdropping to another's signal because of the redirecting of the optical signals to various optical network units.

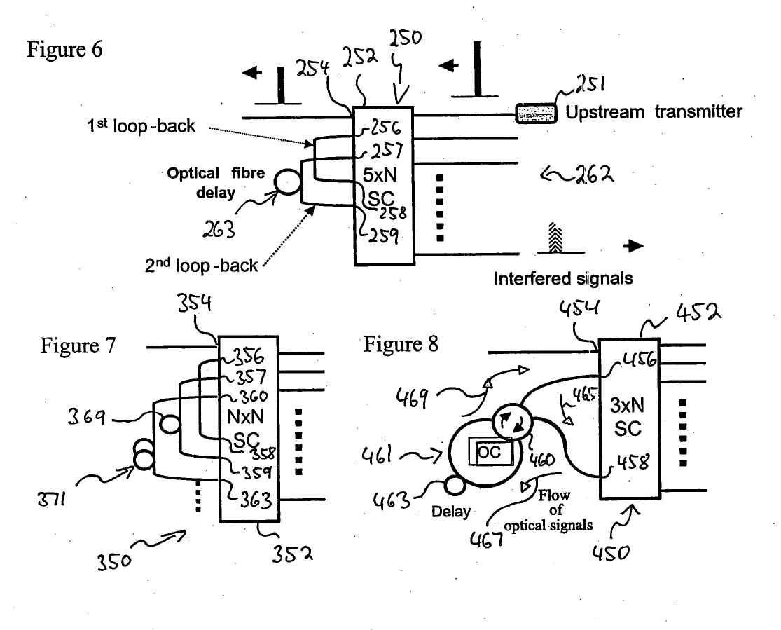

In a modified embodiment of the present invention shown in FIG. 6, a combiner/distribution unit 250 comprises an optical coupler in the form of a 5×N coupler 252. A first upstream port 254 is used for transmission (spectrum C, originating from an LED transmitter 251) to an optical terminal unit (not shown). Pairs of the remaining four upstream ports are interconnected, i.e. ports 256 and 258, and ports 257 and 259. Furthermore, the interconnection of one of the pairs, in the embodiment shown in FIG. 6 the interconnection between ports 257 and 259, further comprises an optical delay, indicating in FIG. 6 as a delay loop 263.

Accordingly, a reflected portion (spectrum B) of an original transmission signal (spectrum A) which is redirected towards the various optical network units 262, comprises an “overlap” signal of the respective portions redirected through the interconnection between the upstream ports 256, 258, and the interconnection between upstream ports 257, 259. As a result, the redirected signal (spectrum B) can not be correctly recovered at the various optical network units 262.

FIG. 7 shows another embodiment of a combiner/distribution unit 350 embodying the present invention. This combiner/distribution unit 350 comprises an optical coupler in the form of a N×N coupler 352. A first upstream port 354 is used for transmission to an optical terminal unit (not shown). Furthermore, a number of pairs of the remaining upstream ports are interconnected, e.g. upstream ports 356 and 358, ports 357 and 359, and upstream ports 361, 363. Each of the interconnects between pairs of upstream ports is characterised by a different optical delay, indicated in FIG. 7 by optical delay loops 369, 371.

It will be appreciated by a person skilled in the art that, when using a N×N coupler 352, utilising more than two loop-back connections increases the optical power available for carrier sensing and collision detection with the same or different delays, which can reduce errors in the carrier sensing and collision detection.

In FIG. 8, yet another combiner/distribution unit 450 embodying the present invention, comprises an optical coupler in the form of a 3×N coupler 452. A first upstream port 454 is used for transmission to an optical terminal unit (not shown), while the other two upstream ports 456, 458 are interconnected via an optical circulator 460. The optical circulator 460 has four ports, two of which are interconnected by a further optical interconnect 461, including an optical delay illustrated as an optical delay loop 463.

In use, portions of an original transmission signal entering the coupler 452 e.g. at downstream port 463 exit at both upstream ports 456 and 458. While the signal entering at upstream port 456 re-enters the coupler 452 via the optical circulator 260, as indicated by arrow 465, the portion exiting at upstream port 458 is directed via the interconnect 461 and re-enters the coupler 452 at upstream port 456, as indicated by arrows 467 and 469.

Again, “overlap” is thus effected between the two redirected signal portions such that the resulting redirected signal can not be correctly recovered at the various optical network units (not shown).

It will be appreciated by a person skilled in the art that, where the embodiments shown in FIGS. 6, 7 or 8 are implemented with laser transmitters, optical polarisation controllers may also be used in the loop-back paths to control the polarisation of the redirected signal portions. For laser transmitters, interference of the redirected signal portions will occur, and it is beneficial to maintain a stable interference pattern. Preferably, the polarisation between two redirected signal portions (compare FIG. 6 when implemented with a laser transmitter) are controlled so that they have right-angled (orthogonal) polarisation states with respect to one another. The result is that the total power in the redirected signal is the sum of the individual powers of the redirected signal portions, which is typically very stable.

Furthermore, in implementation with laser transmitters, optical isolators or alternative means such as polarisation fibres or polarisation maintaining waveguides are preferably used in any of the loop-back paths, to select only one propagation direction. The single direction selection within the loop-backs avoids unwanted interference effects.

Furthermore, it will be appreciated that in the example embodiments described above with reference to FIGS. 6, 7, and 8, the introduction of optical delay through optical path length variation is an illustrative example only. Other means for effecting jamming of the redirected signal may be used, including electronic circuits, for achieving that the redirected portion of the transmission signal cannot be reconstructed at the various optical network units for security reasons.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. An optical network comprising:
a plurality of optical network units,
an optical line terminal unit, and
a first optical combiner unit,
wherein the optical network units are optically connected to the first optical combiner unit via respective optical connections in a manner such that optical transmissions from the optical network units are combined onto one optical line connection to the optical line terminal unit,
a redirection unit for redirecting a portion of a transmission signal on the optical line connection towards the first combiner unit,
each optical network unit comprising:
an optical transmitter unit for transmitting an optical signal to the optical line terminal unit, and
a dedicated CSMA/CD unit associated with the optical transmitter unit and arranged, in use, to tap oft at least a portion of the redirected portion of the transmission signal from the optical connection between the optical network unit and the first combiner unit,
wherein the CSMA/CD unit is further arranged to control the transmitter unit based on the tapped off portion of the redirected portion of the transmission signal.

2. An optical network as claimed in claim 1, wherein the first optical combiner unit comprises an optical star coupler.

3. An optical network as claimed in claim 1, wherein the redirection unit comprises a reflection grating for reflecting the portion of the transmission signal.

4. An optical network as claimed in claim 3, wherein the reflection grating comprises a Bragg reflection grating.

5. An optical network as claimed in claim 1, wherein the redirection unit comprises:
a tap unit for tapping off the portion of the transmission signal,
a second optical combiner unit, and
an optical redirecting connection disposed between the tap unit and the second optical combiner unit for redirecting the tapped off portion of the transmission signal towards the first optical combiner unit.

6. An optical network as claimed in claim 5, wherein the first and second combiner units are implemented as one combiner unit.

7. An optical network as claimed in claim 1, wherein the redirection unit and the first optical combiner unit are implemented as a 3×N optical combiner, wherein two of the, in use, upstream ports are interconnected for, in use, effecting the redirecting.

8. An optical network as claimed in claim 1, wherein the optical transmitter unit comprises a light emitting diode or a laser source.

9. An optical network as claimed in claim 1, wherein the optical network comprises an access network.

10. An optical network as claimed in claim 1, wherein the CSMA/CD unit is arranged to control the transmitter unit based on the intensity of the tapped off portion of the redirected portion of the transmission signal.

11. An optical network as claimed in claim 10, wherein the CSMA/CD is arranged to effect stopping transmission from the transmitter unit when the intensity of the tapped off portion is equal to or exceeds a predetermined threshold value.

12. An optical network as claimed in claim 1, wherein the CSMA/CD unit is arranged to effect restarting of the transmission from the transmitter unit after a predetermined delay period.

13. An optical network as claimed in claim 12, wherein the CSMA/CD units of the respective optical network units are arranged to restart the transmission from the respective transmitter units after different delay periods.

14. An optical network as claimed in claim 1, wherein the CSMA/CD unit comprises an optical tap unit for tapping off the portion of the redirected transmission signal.

15. An optical network as claimed in claim 1, wherein the CSMA/CD unit comprises an optical circulator for tapping off the redirected transmission signal.

16. An optical network as claimed in claim 1, wherein the redirected portion of the transmission signal is a dedicated portion for the redirecting process as opposed to other portions carrying data intended for transmission to the optical line terminal unit.

17. An optical network as claimed in claim 1, wherein the redirection unit further comprises means for jamming of the redirected portion of the transmission signal.

18. An optical network as claimed in claim 17, wherein the means for jamming the redirected signal comprises means for combining copies of the redirected portion of the transmission signal, wherein, in use, an optical delay is imposed on one of the copies prior to the combining.

19. An optical network as claimed in claims 17, wherein the means for effecting the jamming of the redirected portion of the transmission signal comprises an electronic circuit for manipulating the redirected portion of the transmission signal.

20. An optical network unit for use in an optical network comprising a plurality of optical network units, an optical line terminal unit, and a first optical combiner unit, the optical network units being optically connected to the first optical combiner unit via respective optical connections in a manner such that optical transmissions from the optical network units are combined onto one optical line connection to the optical line terminal unit, and a redirection unit for redirecting a portion of a transmission signal on the optical line connection towards the first combiner unit, the optical network unit comprising:
an optical transmitter unit for, in use, transmitting an optical signal towards the optical line terminal unit, and
a dedicated CSMA/CD unit associated with the optical transmitter unit and arranged, in use, to tap off at least a portion of the redirected portion of the transmission signal from the optical connection between the optical network unit and the first combiner unit,
wherein the CSMA/CD unit is further arranged to control the transmitter unit based on the tapped off portion of the redirected portion of the transmission signal.

21. An optical network unit as claimed in claim 20, wherein the optical transmitter unit comprises a light emitting diode or a laser source.

22. An optical network unit as claimed in claim 20, wherein the CSMA/CD unit is arranged to control the transmitter unit based on the intensity of the tapped off portion of the redirected portion of the transmission signal.

23. An optical network unit as claimed in claim 22, wherein the CSMA/CD unit is arranged to effect stopping transmission from the transmitter unit when the intensity of the tapped off portion is equal to or exceeds a predetermined threshold value.

24. An optical network unit as claimed in claim 20, wherein the CSMA/CD unit is arranged to effect restarting of the transmission from the transmitter unit after a predetermined delay period.

25. A optical network unit as claimed in claim 20, wherein the optical network comprises an optical access network.

26. An optical combiner unit for use in an optical network comprising a plurality of optical network units, an optical line terminal unit, the optical network units being optically connected to the optical combiner unit via respective optical connections in a manner such that optical transmissions from the optical network units are combined onto one optical line connection to the optical line terminal unit, the optical combiner unit comprising:
a redirection unit for, in use, redirecting a portion of a transmission signal on the optical line connection to each optical network unit,
wherein the redirected portion is chosen in a manner which provides, in use, that the redirected portion of the transmission signal functions as a reference signal in a CSMA/CD technique conducted at the optical network units, and
wherein the optical combiner unit further comprises means for jamming of the redirected portion of the transmission signal.

27. An optical combiner unit as claimed in claim 26, wherein the means for jamming the redirected portion of the transmission signal comprises means for combining copies of the redirected portion of the transmission signal, wherein, in use, an optical delay is imposed on one copy prior to the combining.

28. An optical combiner unit as claimed in claim 26, wherein the means for effecting the jamming of the redirected portion of the transmission signal comprises an electronic circuit for manipulating the redirected portion of the transmission signal.

29. An optical combined unit wherein the optical network comprises an optical access network.

30. A method of conducting upstream transmissions from optical network units in an optical network, the method comprising:
combining optical transmissions from the optical network units onto one optical line connection,
redirecting a portion of a transmission signal on the optical line connection back towards to the network units,
tapping off at least a portion of the redirected portion of the transmission signal at each optical network unit utilising a dedicated CSMA/CD unit, and
controlling transmissions from the optical network units based on the tapped off portions of the redirected portion of the transmission signal.

31. A method as claimed in claim 30, wherein the step of controlling the transmissions from the optical network units comprises determining the intensities of the tapped off portions of the redirected portion of the transmission signal.

32. A method as claimed in claim 31, wherein the step of controlling comprises effecting stopping transmissions from individual optical network units when the respective intensities of the tapped off portions are equal to or exceed predetermined threshold values.

33. A method as claimed in claim 30, wherein the step of controlling comprises restarting of the transmission from the individual optical network units after predetermined delay periods.

34. A method as claimed in claim 33, wherein the step of controlling the respective optical network units comprises restarting the transmissions from the respective optical network units after different delay periods.

35. A method as claimed in claim 30, wherein the method further comprises the step of jamming the redirected portion of the transmission signal.

36. A method as claimed in claim 35, wherein the jamming of the redirected portion of the transmission signal comprises combining copies of the redirected portion of the transmission signal, wherein an optical delay is imposed on one of the copies prior to the combining.

37. A method as claimed in claim 35, wherein the jamming of the redirected portion of the transmission signal comprises utilising an electronic circuit.

38. A method as claimed in claim 30 wherein the optical network comprises an optical access network.
